(19) United States
(12) Patent Application Publication
(10) Pub. No.: US 2024/0187218 A1
(43) Pub. Date: Jun. 6, 2024

(54) GENERATION OF SIGNING KEYS

(71) Applicant: Hewlett-Packard Development Company, L.P., Spring, TX (US)

(72) Inventors: Chee Keat Fong, Spring, TX (US); Shefali Jain, Pune (IN); Joshua Serratelli Schiffman, Bristol (GB); Thalia May Laing, Bristol (GB)

(73) Assignee: Hewlett-Packard Development Company, L.P., Spring, TX (US)

(21) Appl. No.: 18/554,888

(22) PCT Filed: Jan. 24, 2022
(86) PCT No.: PCT/US2022/013471

§ 371 Date: Oct. 11, 2023

(30) Foreign Application Priority Data
Jun. 5, 2021 (IN) 202141025083

(51) Int. Cl. H04L 9/08

(52) U.S. Cl. CPC H04L 9/0825; H04L 9/085

(57) ABSTRACT

An apparatus, machine-readable instructions and a system to provision partial signing keys to approver devices are provided. A first plurality of partial signing keys is provisioned to a set of first approver devices. A request to execute a command is received and forwarded to multiple ones of the first approver devices. Responsive to the forwarded request, a threshold number of distinct partial signatures are received indicating approval for execution of the command, the approval being verifiable by combining of the threshold number of different partial signatures to generate a complete signature. The apparatus provisions a further partial signing key to a further approver device subsequent to execution of the approved command.

### BACKGROUND

Networked devices, such as computing devices of a Local Area Network (LAN) or a Wide Area Network (WAN) may be managed via a device management service. Device management services may execute commands to perform tasks such as, for example, device configuration, device troubleshooting, device updating, device rollback or remote management. To maintain integrity of the networked computing system and the individual computing devices, management commands may be implemented subject to approval by a trusted user, such as a system administrator.

### BRIEF INTRODUCTION OF THE DRAWINGS

Example implementations are described below with reference to the accompanying drawings, in which:

FIG. 1 schematically illustrates an example computing system for initialising approver devices to contribute to approval of management commands;

FIG. 2 schematically illustrates an example apparatus arrangement in which a threshold sharing scheme is used to sign commands to manage remote authorization for command execution on a target device;

FIG. 3 schematically illustrates an example signal exchange sequence for enabling encrypted communication between a system manager and approver devices;

FIG. 4 schematically illustrates an example signal exchange sequence for initialising approver devices to approve management commands using a coding scheme;

FIG. 5 is a signal exchange diagram that schematically illustrates an example authorization procedure;

FIG. 6 is an example flowchart schematically illustrating provision of partial signing keys of a coding scheme to remotely authorise management commands; and

FIG. 7 schematically illustrates example machine readable storage and machine readable instructions for generating, using a threshold scheme, signing keys for management commands.

### DETAILED DESCRIPTION

Solutions for mediating execution of management commands may involve cumbersome set-up stages to register multiple trusted users to provide approver devices to approve those commands and to allow for some redundancy in the command management system to take account of potential unresponsiveness or unavailability of trusted users. Initialising those multiple trusted users to allow them to authorize incoming management command requests via approver devices in a secure way may needlessly delay the execution of management commands. For example, registration of all trusted users selected as approvers by a system administrator may be performed before requested commands can be executed. Examples of the present technique expedite the ability to approve commands even when there are multiple approver devices to be initialised (i.e. registered with the system).

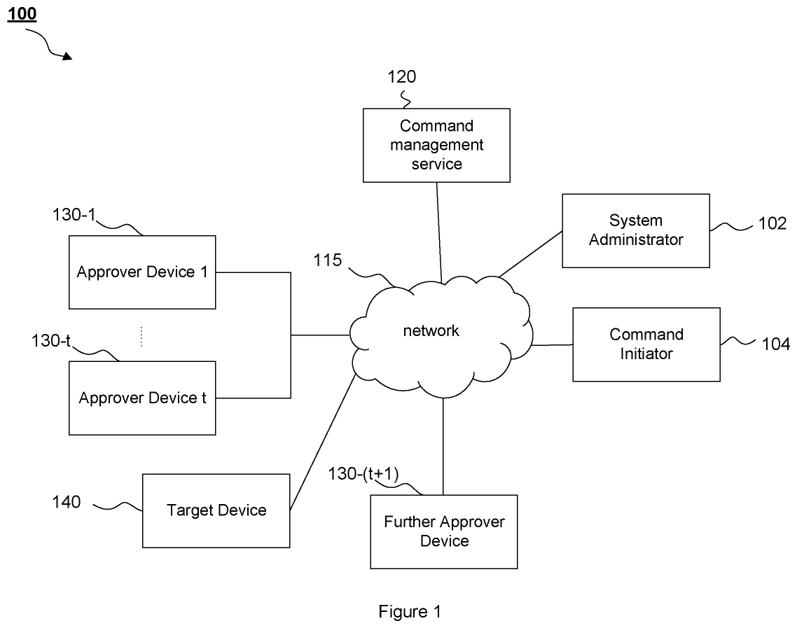

FIG. 1 schematically illustrates an example computing system 100 for setting up approver devices to contribute to collaborative approval of management commands. The computing system 100 comprises a system administrator 102, a command initiator 104 to request execution of a management command, a network 115, a command management service 120, a plurality of approver devices 130-1, to 130-t, a further approver device 130-(t+1) and a target device 140 on which a management command is to be executed.

In some examples, a “management command” may include any command to be processed on a computing device whose execution is subject to approval prior to execution, such as a command mediated by the command management service 120. The computing system 100 may correspond to any type of networked computing system, such as, for example, a cloud-based computing system where users remotely connect their devices via a network to access services and data. The computing system 100 may be utilized in a variety of different applications, including, for example, Data as a Service (DaaS) applications, or in any other suitable applications.

The network 115 couples the command management service 120 to the approver devices 130-1 to 130-t, the further approver device 130-(t+1), the system administrator 102, the command initiator 104 and the target device 140. The network 115 may be, for example, a Local Area Network (LAN) or a Wide Area Network (WAN) and may be wired or wireless or a combination of wired and wireless.

The computing system 100 may enable the execution of management commands on any computing device or group of computing devices of the computing system 100, but for illustrative purposes FIG. 1 shows the target device 140 as a device upon which a given management command is to be executed via collaborative approval of a first plurality of the approver devices 130-1 to 130-t using a threshold scheme. A threshold scheme is one example of a secret sharing scheme. Secret sharing refers to methods for distributing a secret amongst a group of participants, each of whom is allocated a share of the secret. The secret can be reconstructed when a sufficient number, of possibly different types, of shares are combined together. The approval is collaborative to the extent that two or more approver devices individually approve execution of the command and approvals from those two or more devices are collated to determine whether or not the command is to be executed. According to the present technique, a threshold scheme is used as a building block in a threshold signature scheme. In the threshold signature scheme, the secret is not reconstructed during the signing process, but instead partial signatures are generated using partial signing keys to sign a command for which execution has been requested by the target device 140. A complete signature is generated from a threshold number of partial signatures for verification by a public key of a threshold asymmetric key pair as a prerequisite for command execution.

By way of contrast, other management systems, which are not examples of the present technique, store a signing key on the command management service 120 (with the corresponding public key being stored on the target device 140), and when the command initiator 104 (or an approver) authenticates to the command management service 120 and issues a command, the command management service 120 may then use the signing key to sign the command and the signed command may then be sent over the network.

A secure secret sharing scheme distributes shares so that anyone with fewer than t shares (where t is an integer greater than one) has no extra information about the secret than someone with no shares at all. In the threshold scheme according to the present technique a “secret” corresponding to a signing key is divided into a total of n shares (partial signing keys) corresponding to a total number of approver devices and n is an integer greater than or equal to t. The number of approver devices may be equal to the number of partial signing keys or may be less than the number of partial signing keys because multiple partial signing keys may be associated with a single approver device. Different partial signing keys may be used by respective different approver devices to generate different partial signatures on the command. The value of t may depend on the parameters and type of the sharing scheme implemented. The collaborative approval of a management command request may involve a threshold number (t) or more, of approvals for execution of a given command request by different ones of the approver devices 130-1 to 130-t. The further approver device 130-(t+1) may be added to the given threshold scheme at a time after a first requested command has been collaboratively approved for execution using the same threshold scheme by the first plurality of approver devices 130-1 to 130-t. The first plurality of approver devices may be a set of approver devices, wherein the set comprises one or more first approver devices. In some examples each of the t partial signing keys may be provisioned to a different approver device with a one-to-one mapping between approver devices and partial signing keys. In other examples, multiple partial signing keys may be provided to a single approver device, such as when an approver has a high level of authority and is trusted by the system to approve management commands either without collaboration with another user or in collaboration with fewer other users than an approver having a default level of authority. Yet further approver devices (not shown) may be incrementally added to the command management service 120 using the same threshold scheme parameters that have already been used to authenticate commands by the previously “initialised” approver devices 130-1 to 130-t that have responded to a request from the command management system to register as an approver.

According to examples of the present technique, the threshold scheme is an example of a secret sharing scheme, and is used to distribute the signing key amongst the multiple devices, and to add approvers to the system, but is not used for actually authorising a command. A threshold scheme may consists of two algorithms:
Share algorithm: takes as input a secret (here, the signing key) and parameters t and n and outputs n shares.
Recover algorithm: takes as input t shares and outputs the secret.
   By way of contrast, a threshold scheme as implemented in examples of the present technique it here has three algorithms:
Initialise algorithm: takes as input a secret and a threshold t, and outputs nothing (setting n=0).
Add algorithm: takes as input+1′ and outputs a share (a partial signing key) (setting n=1)
Recover algorithm: takes as input t shares and outputs a secret (this algorithm is not used in the described examples).
   A threshold signature scheme may consist of three algorithms:
Threshold Key Generation algorithm: takes an input parameters t and n and outputs n shares and a public key. This may generate a signature key pair (signing key, public key) and use a threshold scheme to share the signing key using the parameters t and n. According to examples of the present technique, an ‘initialise/add’ version of the threshold scheme is used to generate partial signing keys.
Threshold signature generation algorithm: uses t shares (in some collaborative protocol, so everyone keeps their share private) and a command to be authorised and outputs a signature on the command.
Threshold signature verification algorithm: run by the target device, which takes as input the public key (which it was sent previously by the command management service where it was generated), the command and the signature on the command and output valid or invalid.

The command initiator 104 represents any computing device of the computing system 100 from which a request to execute a management command originates. In some examples the command initiator 104 may be one of the approver devices 130-1 to 130-t or the further approver device 130-(t+1). In other examples the command initiator 104 may be the target device 140 itself.

The target device 140 may comprise any type of computing device, including, for example: a server; a desktop computer or a laptop computer; a handheld computer such as, for example, a smart phone or a tablet; a wearable computer, such as, for example, a smart watch; a printer; an internet-of things (IoT) smart device; a smart card; or any other type of computing device. Furthermore, although a single target device is illustrated in FIG. 1, some remote management commands according to the present technique may simultaneously target two or more computing devices of the computing system 100 via a single command.

Although the target device 140 is shown in the FIG. 1 example to be distinct from the first plurality of approver devices 130-1 to 130-t and the further approver device 130-(t+1), in other examples the target device 140 may be one of the first plurality of approver devices 130-1 to 130-t, the further approver device 130-(t+1) or any other computing device of the computing system 100 including the system administrator 102. One or more of the approver devices 130-130-t may comprise processing hardware such as a smart card having an integrated circuit or a security token to authenticate the identity of an approver (a human being) on a computing device of a computing system. Alternatively or in addition an approver device 130-130-t may be associated with an approver selected by the system administrator 102 via the user having a unique login identity and associated user profile on the computing system.

In some examples, the command initiator 104 may be the same device as the target device 140. For example, the command initiator 104 may request a command such as “wipe my PC”, which may be sent to the command management service 120 to construct an appropriate command and relay the request to multiple ones of the approver devices 130-1 to 130-t (e.g. a subset of two or more of the approver devices) seeking approval for execution of the wipe command. The execution of the management command may occur directly on a native operating system of the target device 140 or may alternatively occur on a virtual machine running on the target device 140.

The command initiator 104 requests execution of a management command on the target device 140 and the request is either authorized or denied by the target device 140 based on a combination of a threshold number or more partial signatures on the requested command corresponding to a complete signature. The command management service 120 may authenticate the command initiator 104, but then the command management service 120 sends the (unsigned) command to the approver devices, who collaboratively sign the command. In some examples, the command request sent to the approver devices may be signed so that the approver devices can identify that the command originated from the command management service, but this signature is optional and a request may be approved without it. If the command remains the same, and the signature scheme is deterministic, which it is in the examples described in this disclosure, then replacing one partial signature with another (e.g. replacing one of a first plurality of partial signatures with a further partial signature) results in the same complete signature.

However, if the command being authorised changes, the partial signatures generated on the first command no longer apply to the second command, and in such examples the complete signature is different. Resilience to malicious or careless management commands being executed is provided by offering collaborative approval of each command by more than one approver device 130-1 to 130-t such that execution of a requested command depends on authorization by two or more approver devices 130-1 to 130-t. However, where appropriate, a single approver device may be set up in the computing system to have a level of trust such that they are provided with multiple partial signing keys, perhaps even t partial signing keys, to allow a single approver device to approve an incoming command without corroboration with any other approver devices.

Examples of management commands to be requested and authorized or denied collaboratively by the approver devices 130-1 to 130-t and the further approver device 130-(t+1) include, but are not limited to: a find command (e.g., to identify a location of the target device 140); a wipe command (e.g., to erase a memory of the target device 140); a lock command (e.g., to prevent a user utilising the target device 140 e.g., by locking the target device 140 from booting); a command to trigger a firmware update for the target device 140; a command to trigger a software update for the target device 140; a command to modify at a basic input/output system (BIOS) setting of the target device 140; a command to rollback software to a previous version; a command to request execution of a software tool or script or a command to request administrator rights for the computing system, or any combination or permutation of these commands.

Management command requests may be restricted to users having a minimum privilege level in the computing system 100 but could in principle originate from any user via one of the devices of the computing system 100. The users having minimum privilege level may authenticate themselves with the computing system 100 via an identity management service such as a database based system that provides authentication, directory and policy in an operating system environment and may use an associated application protocol for querying and modifying information in the database.

The command management service 120 may be instantiated on a server such as a secure server. The server may be remote or on the same premises as the computer network 100. Any form of service architecture may be used, such as a microservice architecture. The command management service 120 may be distributed across two or more servers or other computing devices. The command management service 120 may be responsible for one or more of the following in any permutation or combination:
1) Authenticating system administrators 102 and managing the group of approver devices 130-1 to 130-(t+1) allowed to issue commands
2) Generating threshold asymmetric key pairs for management commands
3) Generating partial keys (“shares” of a secret) from a secret key of the threshold asymmetric key pair
4) Sending an unsigned command from a target device to the approver devices
5) Distributing public threshold keys of the threshold asymmetric key pairs to computing devices of the computing system
6) distributing ciphertext versions the partial keys to the group of approver devices 130-1 to 130-(t+1)
7) Receiving partial signatures on a command from the group of approver devices 130-1 to 130-(t+1)
8) Logging which of the approver devices 130-1 to 130-(t+1) issues a partial signature for each requested command
9) Blocking signatures by rogue or revoked computing devices
10) Combining the partial signatures received from a plurality of the approver devices 130-1 to 130-(t+1) into a complete (i.e. full) signature
11) Forward the partial signature and command to the target device With regard to item 9), the partial signatures from each one of the plurality of the approver devices 130-1 to 130-(t+1) that have partially signed a command indicating an approval response to the command request may alternatively be forwarded to the target device 140 where the combination of partial signatures may be performed.

Thus the computing system 100 uses the command management service 120 to mediate requests for management commands and provides a secure service allowing a command to be partially signed by a plurality of the approver devices 130-1 to 130-(t+1) as a prerequisite to executing the command on the target device 140.

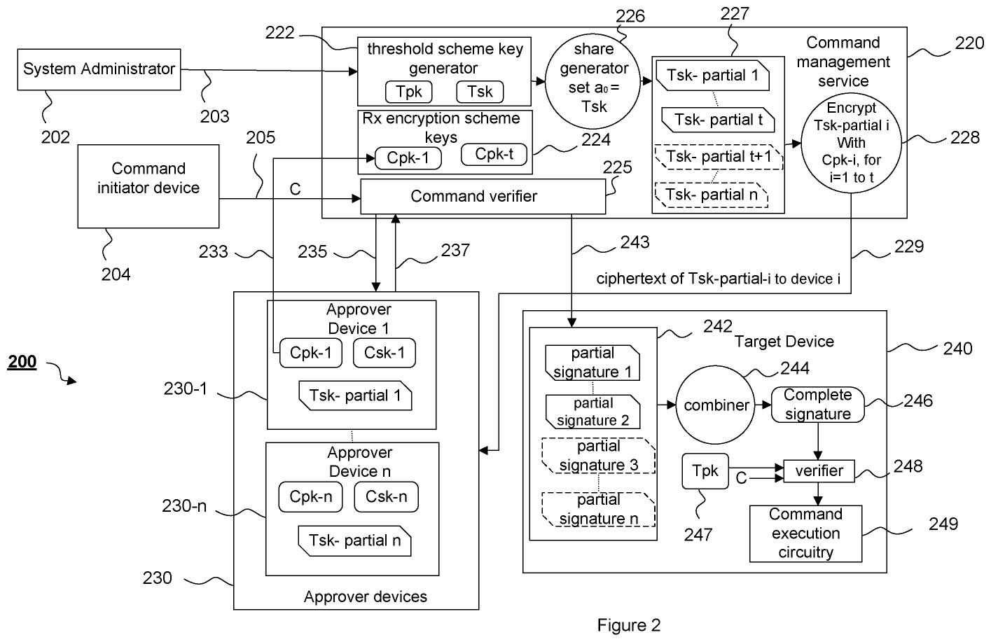

FIG. 2 schematically illustrates an apparatus arrangement in which a threshold sharing scheme is used to sign commands to manage remote authorization for command execution on a target device. The system comprises a system administrator 202, a command initiator device 204, a command management service 220, a set of approver devices 230 and a target device 240. The set of approver devices may comprise one or more approver device. The command management service 200 has a threshold scheme key generator 222 to generate an asymmetric key pair for use in a threshold sharing scheme. The key pair 222 comprises a public key, “Tpk”, and a private key, “Tsk”. The command management service 220 also has storage 224 for public keys, Cpk-1 to Cpk-t, received from each of a plurality of the approver devices 230-1 to 230-n. These cryptographic keys are one half of a key pair (Cpk-i, Csk-i) generated by each ith approver device 230-1 to 230-n (i=1 to n) as it is set-up by the command management service 220. The encryption key pairs (Cpk, Csk) may be used so that the command management service can securely transfer the partial signing keys from the command management service (e.g. secure server) to the approver devices.

The system administrator 202 may set an approver list comprising a plurality of approvers having associated approver devices. At the outset, the approver list may comprise a threshold number, t, of approvers, because t is the minimum number of approvers upon which a command authorization can be based. However, in some examples more than one partial signing key may be associated with a single approver device, in which cases there may be fewer than t approver devices although there are t partial signing keys. The system administrator 202 may provide t as an input parameter for the threshold scheme. In some examples, the system administrator 202 may send a parameter n corresponding to a total number of approver devices to be allocated command authorization rights, where n is an integer greater than t.

The system administrator 202 may provide a list of device identifiers for t of the authorisers and may further provide one or more further device identifiers up to a total of n device identifiers. The system administrator 202 may identify the n users that they wish to elect as approvers via their associated approver devices and may notify those elected users by email, by text message, by instant message or by any other means. The user notification may be via the command management service 220, which stores and maintains a list of currently authorized approver devices. Responsive to the notification, the elected users may complete an “add approver” registration process to prepare them for participation in the threshold scheme command authorization. The system administrator 202 may notify the n elected users to perform the registration in advance to the threshold parameter t being chosen.

An initialisation procedure of the threshold scheme for generating signing keys for management commands comprises the command management service receiving the parameter t from the system administrator 202 via the signal 203 and using the threshold scheme key generator 222 generates a public key and private key pair (Tpk, Tsk) for use in the threshold scheme. In the example of FIG. 2, Shamir's threshold scheme is used. In alternative examples different threshold schemes including Blakely's scheme, Mignotte's scheme and Asmuth-Bloom's scheme may be used. Threshold schemes may be applied, for example, to signature schemes such as Rivest-Shamir-Adelman (RSA) signatures, Digital Signature Algorithm (DSA) signatures, Elliptical Curve Digital Signature Algorithm (ECDSA) signatures and Schnorr signatures. The present technique is not limited to any specific threshold signature scheme.

According to Shamir's scheme, a polynomial, f(x), of degree (t−1), is defined such that:

f(x)=a₀+a₁x+a₂x²+ . . . +aₜ₋₁x^{t-1} equation (1)

The share generator 226 generates t−1 positive integers a₁, . . . , aₜ₁, using a random number generator, for example. The set of polynomial coefficients a0, a1, . . . , at−1 together with the value of t characterise a given coding scheme. The “secret” to be shared is set by the share generator 226 to be equal to the private threshold scheme key Tsk output by the threshold key generator 222 such that the y-intercept of the polynomial f(x) is the secret. The share generator 226 may calculate t shares, but up to n shares by computing f(1), . . . , f(t), f(t+1), . . . , f(n). In some examples, zero shares could be generated initially, with approvers being added at a later point although a command cannot be issued until t shares are generated. Thus f(1) is a first partial signing key, f(2) is a second partial signing key and so on. The shares need not be calculated such that the ith share is f(i), instead a number of distinct x values corresponding to the number of partial shares to be created may be used, where x is any number greater than 0.

An intuitive way of understanding Shamir's scheme is that two points are sufficient to define a line (a polynomial of degree one), whereas a single point could define an infinite number of lines; similarly, three points are sufficient to define a parabola (a polynomial of degree two) whereas two points could define an infinite number of parabolas, etc. In Shamir's scheme, a random polynomial of degree t−1 is defined, so any t points (here, the points are ‘shares’) define the random polynomial whereas fewer than t points could define an infinite number of polynomials. Once t shares are combined, polynomial interpolation can be used to recover the polynomial, and thus the y-intercept of the polynomial which is the secret, a0, in equation (1). Thus in FIG. 2, the partial signing keys 227 are such that Tsk-partial 1=f(1), Tsk-partial 2=f(2), Tsk-partial t=f(t) and so on. Thus the partial signing key provided to each different approver device 230-1 to 230-n is different or distinct because it corresponds to the polynomial evaluated at a different value of x. Although in some examples. Multiple partial signing keys may be provisioned to a single approver device. A new authoriser can be added at a later time by evaluating the polynomial at a new different value of x, provided that the coefficients a₁, . . . , aₜ₋₁ specific to the given threshold coding scheme are accessible. An unlimited number of shares may be created for any given Shamir threshold scheme.

Threshold schemes such as Shamir's threshold scheme uses strings of randomness to generate shares of a secret. In Shamir's scheme the randomness is the values of the polynomial coefficients. In alternative threshold schemes that could be used on other examples of the present technique the randomness may be, for example, entries in a matrix or a vector, or just values that are added rather than polynomial coefficients.

One implementation of a command management system using a plurality of approver devices to authorize a requested command could have an initialization phase during which all possible approver devices are to generate an encryption key pair (Cpk, Csk) responsive to a notification requesting that they register as an approver and to upload their public encryption key Cpk to the command management service 220. After each and every user selected as an approver has registered can a first command be authorized. In such an implementation ciphertext shares created by using the uploaded public key of each approver device 230-1 to 230-n to encrypt the partial signing key 227 of the threshold scheme intended for the corresponding approver device, may be output by the command management system 220 as part of an initialisation stage. The partial signing keys 227 are the “shares” of the secret, Tsk, in the threshold scheme.

According to the present technique, the threshold scheme is used to distribute a signing key and the share output is the partial signing key 227. The threshold scheme is applied to a signature scheme according to examples of the present technique. A signature scheme has three algorithms:
1. Key generation
   a. Input: for example, a security parameter of the scheme such as a size of the key to generate key pair
   b. Output: an asymmetric key pair (public key, private key)=(Tpk, Tsk) in FIG. 2.
2. Signature generation
   a. Input: a message (a command C) to be signed, the private key Tsk
   b. Output: a signature (sig)
3. Signature verification
   a. Input: C, sig, Tpk
   b. Output: valid or invalid.

The present technique uses a threshold signature scheme, according to which a threshold scheme is used to distribute the signing key Tsk (private key) into multiple shares (or ‘partial signing keys’). The threshold signature generation procedure according to this example comprises the approvers being sent the command, and each approver device locally running a signature generation algorithm which takes as input a partial signing key specific to the approver and the command for which authorisation for execution is requested. An output of the signature generation algorithm is a partial signature, which is sent to the server and combined to produce a complete (i.e. full) signature, which can then be verified by the target device prior to executing the command. The signature generation may comprise signing information in addition to the command C. For example, one or more of an identifier of one or more target device; a timestamp corresponding to the command request; and an identifier of the command requestor, may be sent with the command and may be signed with the partial signing key.

The FIG. 2 example is one example of a threshold signing algorithm, and other examples (e.g. threshold ECDSA) may involve more rounds of communication between approvers. In one alternative example, the command may be sent to the multiple approver devices, who all generate some randomness and broadcast a commitment to their randomness, then broadcast their randomness. The randomness of all approver devices is then used in a function call, and all approver devices output their partial signature, or even the full signature

The initialisation stage of the command management system might then be followed by an approval stage in which commands can then be authorised by approver devices 230 accessing their ciphertext partial signing key (their share) and using their private decryption key Csk-i to decrypt the ciphertext partial signing key to participate in collaborative authorization of commands. However, such an implementation has the issue that no commands can be authorised until all approvers have responded to the request to register with the management service, for example, by providing the public key Cpk-i. Thus if any one of the total number, n, of approvers delays registering as an approver and uploading a public key, due for example to being on holiday, then no commands can be sent even if the threshold number of approvers or more have already registered.

To ameliorate this issue, examples according to the present technique may initialise the command management system 220 without requiring any of the n approver devices to register, but simply notifying the approver devices that they are being invited to register and the system administrator 202 supplies the parameter t to the command management system 220. The ciphertext partial signing keys are not output as part of the initialisation stage in this case. Instead, after completion of an initialisation stage in which no users need have registered with the command management service 220, an “add approver” procedure may be executed up to n times, such that add approver may be executed once for each of individual approver devices 230-1 to 230-n. The add approver procedure comprises an approver device generating an asymmetric cryptographic key pair (Cpk-i, Csk-i), sending the public key Cpk-i to the command management service 220 and further comprises the command management service 220 generating a partial signing key 227 specific to the approver device, encrypting the partial signing key using the public key Cpk-i and sending the encrypted partial signing key to approver device i for use in a command approval procedure. The approval procedure may be successfully run to authorize a first command using the threshold scheme selected based on t, after the add approver procedure has been executed t times.

As shown in FIG. 2, the first approver device 230-1 of the group of approver devices 230 has access to a cryptographic key pair (Cpk-1, Csk-1) which is a (public key, private key) pair generated by the first approver device 230-1 responsive to an invitation from the system administrator 202 via the command management service 220 to register as an approver device. The public key of this cryptographic pair Cpk-1 is sent to the command management service 220 by the first approver device 230-1 as part of the add approver procedure for that device. This encryption public key Cpk-1 may be used by an encryption process 228 in the command management service 220 to encrypt the partial signing key Tsk-partial 1 to create a cipher text version of Tsk-partial 1 for sending via signal 229 to the approver device 1 230-1 to complete the add approver procedure for the approver device 1 230-1. Similar add approver procedures may be run for each of the approver devices 1 to n. After a threshold number of add approver procedures have been run, it becomes possible to successfully run a command approval procedure. The command approval procedure comprises a command, C, being sent from the command initiator device 204 to a command verifier 225 in the command management service 220. The command verifier, may check an approver list, which may be dependent on the type of command or the identity of the device 204 from which the command originated via a command approval request 235 or both the command type and the device identity. The command verifier 225 sends to each of the approver devices 230 authorized to approve the command C, the command approval request 235 to approve the command, which identifies the command.

The command approval request 235 sent to multiple registered approver devices in this example may include one or more of: the command; a command identifier; identifiers for the target device(s) on which C is proposed to be executed; a time of the request; a date of the request; an identifier of the command initiator 205. The command C may also be accompanied by a random number or “nonce” so that even successive commands of the same type (e.g. a wipe command) are different from each other. This random number provides resilience of the command management system against a “replay attack”. In examples where the command initiator device 204 is one of the approver devices 230, the command approval request 235 may be signed using the partial signing key corresponding to the originating approver device, in which case the command approval request 235 is a partial signature. To approve execution of the command an approver device of the set 230 of registered approver devices may send a response 237 to the command verifier 225 of the command management system 220.

The response 237 may include the command to which the request for execution relates, partially signed using the responding approver device's plaintext partial signing key. The plaintext partial signing key is only known to the approver device to which it has been one-to one mapped (e.g. first partial signing key to first approver device and so on). The i^{th} ciphertext partial signing key can be converted to plaintext at the i^{th} approver device using the private key Csk-i and the plaintext partial key need not be sent to any other entity. As an alternative to storing the plaintext partial signing key Tsk-partial i at the i^{th} approver device, it may be stored in the network 115 in encrypted form and downloaded by the approver device and deciphered (converted to plaintext) when it is to be used to sign a command.

The signing key f(0) (the “secret”) is constant. Each partial signature produced by the approver devices is dependent on both their particular partial signing key (which can remain constant and private) and the command being signed. Thus the full signature (which is a combination of the partial signatures) may be different for each command being signed. If the full signature was the same for multiple commands, an attacker might be able to send an arbitrary command with the (known) secret. Hence, according to the examples described, the signature is tied to and dependent on the command, and the private inputs (the partial signing keys).

The response 237 to the command request may further comprise, in addition to the partial signature, one or more of: a identifiers for a target device or set of devices upon which the command is to be executed; a time or time range in which the command is to be executed; a time when the request was made; an identifier of the command initiator; a random number or nonce. In this example, all of the partial signing keys returned from the approver devices 230 responsive to the command approval request 235 are returned to the command verifier 225, which either forwards the partial signatures 242 to the target device 240 or combines the partial signatures into a full signature, which is then sent to the target device. According to the present technique, the plaintext partial signing keys can remain on the approver device without sending them to another entity and thus can remain confidential to the approver.

The target device 240 may receive a plurality of the partial signatures depending on the responses 237 from the approver devices 230 regarding execution or denial of execution of the command and the target device supplies them to a combiner 244 to generate a complete signature 246.

The command verifier 225 of the command management service 220 in the FIG. 2 example does not combine the partial signatures received by it via the response 237 itself, but instead triggers combination of the partial signatures by the combiner 244 of the target device 240 by forwarding the partial keys to the target device via the signal 243. However, the command verifier 225 does combine the partial signatures in alternative examples as described below.

The complete signature 246 may be verified by inputting it to a verifier process 248 alongside the command and the public key Tpk 247 of the asymmetric key pair 222 associated with the threshold scheme (second input to verifier 248). The threshold public key Tpk may be provisioned to all approver devices at any time after the key pair has been generated and before a first command is authorised. Target devices use the Tpk for complete signature verification. Although approver devices may be target devices, target devices can be other than approver devices. In the example of FIG. 2, the partial signatures are combined at the target device 240, but in alternative examples, the partial signatures may be combined by a combiner forming part of the command management service 220 or at another computing device of the computing system 100 of FIG. 1. In examples where the command management service 220 combines the partial signatures, the command management service 220 may forward the command and the complete signature to the target device 240 for execution. The verification of the complete signature with the public key, Tpk, may be performed at the target device 240. The device target device 240 may execute the command if the complete signature is valid. The command management service performing the signature is optional and may be performed for auditing purposes, for example.

According to the present technique, a command management service may implement generation of keys for authorizing execution of management commands using four procedures: (i) an initialisation procedure; (ii) an add approver procedure and (iii) a command approval procedure; (iv) verification by the target device. In the command approval procedure, the approval devices use their partial signing keys to produce partial signatures rather than send their partial signing keys to the command management service. Thus the partial signing keys can be kept securely on the approver devices. Decoupling the add approver procedure from setting the order of and coefficients for the polynomial of the threshold sharing scheme facilitates the command approval procedure to be run before all n approver devices have been on-boarded as approvers and allows the command approval procedure to run after t or more approver devices, comprising any subset of the n approver devices, have been on-boarded. Further approvers can be added to the same threshold sharing scheme even after the command approval procedure has been run. The same threshold scheme may have the same characteristic parameters such as, for Shamir's scheme, the same polynomial coefficients and the same polynomial order. As shown in FIG. 2, the threshold secret key Tsk is not revealed to the approver devices 230. The value of Tsk may be needed to add further shares at a time subsequent to the first plurality of partial shares having been generated. This can be accomplished by storing Tsk securely in the command management service for use when appropriate for further partial key generation. For this purpose Tsk could be stored such that it is secure from discovery and malicious use. For example, access to Tsk could be restricted to the system administrator based on a two-factor authentication.

Alternative examples of the initialisation procedure include the following variations:
i. One of the n approver devices 230 specified by the system administrator 202 in the initialisation procedure could execute the add approver procedure at a much later date.
ii. The system administrator 202 could run the system as defined with parameters t and n, then contact the command management service 220 at a later date (potentially after many commands have been authorised) to increase n to n+1, then send an invite to an n+1th approver and this approver may run the add approver function as and when appropriate.
iii. The system administrator 202 could set n during the initialisation procedure to be an upper bound on the number of approver devices desired in the system at any one time, but choose and invite n′ employees to be approvers, where n≥n′≥t. The system administrator 202 could then invite further approvers (up to n−n′) at a later point in time.
iv. The system may fully decouple n from the initialisation procedure, so that during initialisation the system admin specifies t but not n, and then sends invites to approvers to join the system as and when appropriate. The secure server may implement this by initialising with n=0, and then increase n each time a new approver registers with the command management service 220.

As long as the system administrator 202 chooses the parameter t during the initialisation procedure, the command management system 220 can be initialised and commands can be approved as soon as t or more approvers have registered with the command management system 220. The other approvers (n−t approvers, or however many more approvers are invited by the system administrator 202 if the parameter n is undefined) could be invited to register or could register based on an earlier as yet unanswered invitation to register after the command approval procedure has already been run for one command. In some examples no commands are run but the system allows commands to be approved prior to registration (initialisation) of all of the approvers.

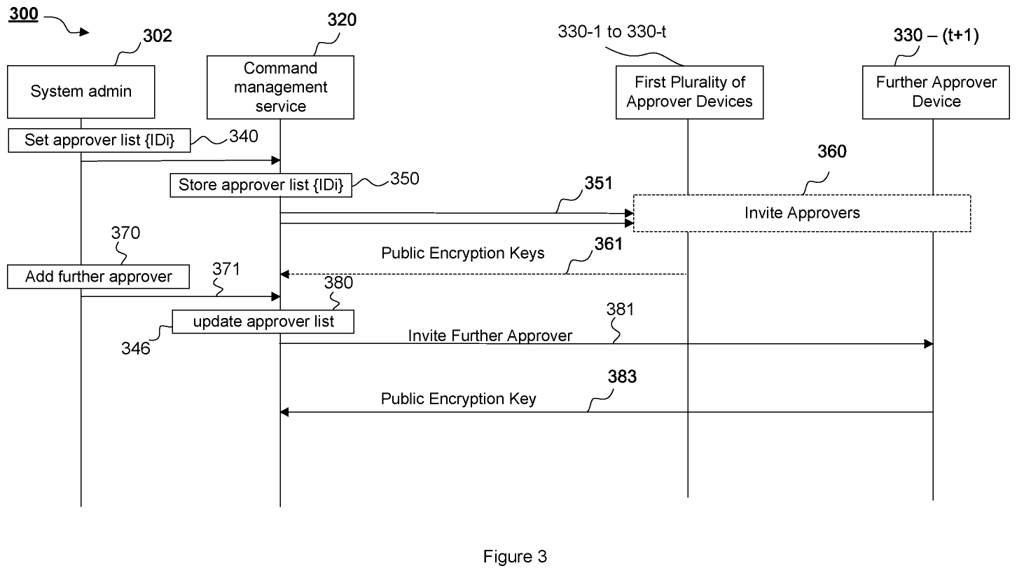

FIG. 3 schematically illustrates an example signal exchange sequence for enabling encrypted communication between a system manager and a plurality of approver devices. The signal sequence 300 involves communications between a system administrator 302, a command management service 320, a first plurality of approver devices 330-1 to 330-t and a further approver device 330-(t+1). At 340 the system administrator sets an approver ID list. The approver list may be defined by the system administrator, who may set approver groups depending on one or more of: the type of command; the specific target or target device (not shown in FIG. 3); and the device or type of device from which the command originated. Alternatively, in a simpler implementation, all management commands may be subject to approval by the same list of approvers. At process 350 the command management service 320 may store a list of trusted approver devices 330-1 to 330-t and may maintain and update this list as it evolves. Approver devices may be added to or removed from the list. In some examples, an incoming partially signed command may be checked against the stored approver list 350 to reduce the likelihood of an unauthorised approver device participating in authorisation of execution of a requested command. At signal sequence 351, the command management service 320 invites approvers of the approver list to register with the command management service 320, for example, by inviting them to run the add approver procedure.

The invitations may be sent to approvers, for example, by email, instant message, SMS message. Next at signal 362 public encryption keys are sent from each approver device to the command management service 320 as part of the add approval procedure. At 370, the system administrator sends a communication to the command management service 320 requesting that a further approver is added to the approver list. After checking that any maximum number of approvers has not been exceeded, the command management service 320 updates the approver list at 380 to add the further approver and invites the further approver to run the add approver procedure. The further approver responds to the invitation by generating an asymmetric key pair and sending the public key to the command management service 320 via communication signal 383. The command management service 320 is then in a position to supply a partial signing key to the further device, encrypted using the public encryption key received via the signal 383. In this example, the further approver device 330-(t+1) is a different device from the first plurality of approver devices 330-1 to 330-t. However, similarly to examples where two or more partial signing keys are associated with a single approver device, the further add approver procedure may allocate a further partial signing key to one of the approver devices that has previously been provisioned with a partial signing key. This may be appropriate if the corresponding approver is to be allocated a higher level of trust than when the first group of partial signing keys was provisioned.

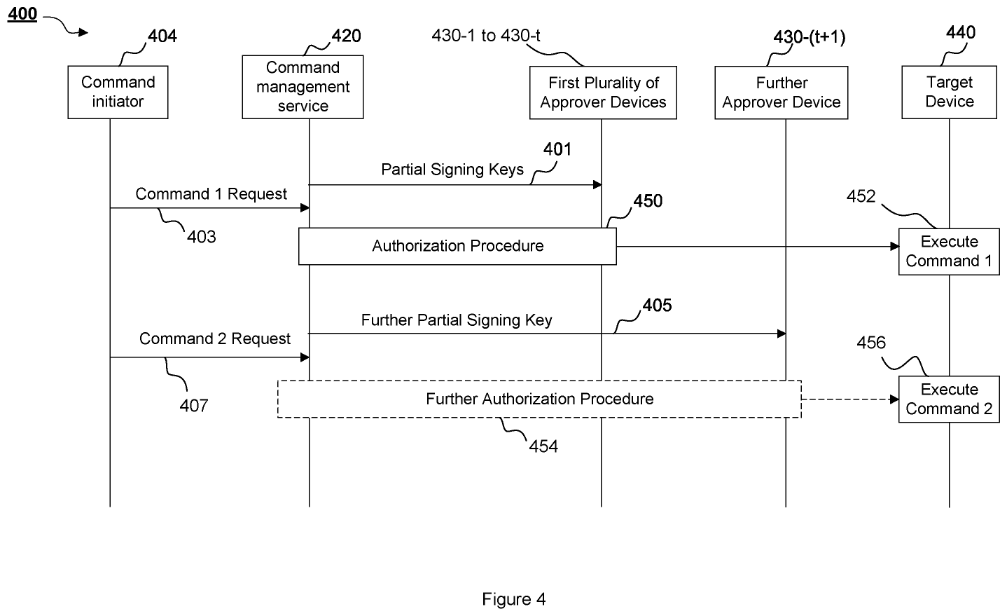

FIG. 4 schematically illustrates an example signal exchange sequence for initialising approver devices to approve management commands using a coding scheme. The signal exchange example illustrated in FIG. 4 represents a command authorisation protocol.

The example communication sequence 400 involves a command initiator 404, a command management service 420, a first plurality of approver devices 430-1, to 430-t, a further approver device 430-(t+1) and a target device 440.

At 401, the command management service 420 provisions a first plurality of partial signing keys to the first plurality of approver devices 430-1 to 430-t, where each partial signing key of the first plurality of partial signing keys is provided to a respective different approver device of the first plurality of approver devices 430-1 to 430-t. In provisioning the first plurality of partial signing keys to the first plurality approver devices 430-1 to 430-t, there may be a one to one mapping between each partial signing key of the set of partial signing keys and each approver device of the set of approver devices 430-1 to 430-t. However, in alternative examples, a single approver device may be allocated multiple partial signing keys such that t partial signing keys may be associated with fewer than t approver devices, perhaps even a single approver device. Thus some approvers in a computing system may have higher levels of authority than others such, for example, a standard level of approver may be set up to collaboratively approve commands with four other approvers, an enhanced level of approver may be set up to collaboratively approve commands with say two other approvers and a top level of approver may be set up to authorise commands independently (e.g. by being associated with t partial signing keys). In examples where more than one partial signing key is allocated to a single approver the multiple partial signing keys may be stored on the same approver device or may be stored on separate approver devices. In further alternative examples, the first plurality of approver devices may comprise more than the threshold number t of approver devices, but less that the maximum number n of approver devices. In the FIG. 4 example arrangement the command management service 420 assumes the role of a central dealer of the threshold sharing scheme, by being a distribution hub for the partial signing keys.

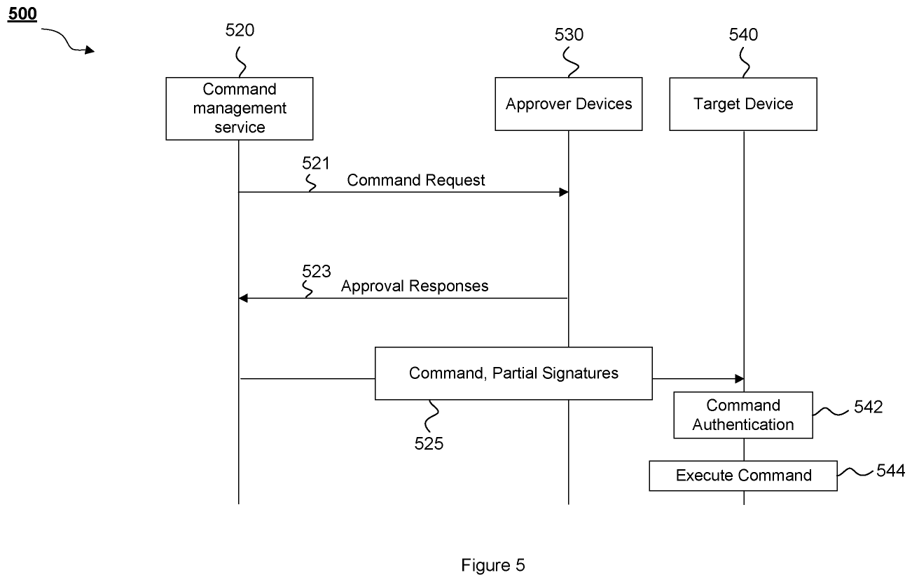

At 403 a first command request is communicated from the command initiator 404 to the command management service 420. Receipt of the first command request by the command management service 420 results in an authorisation procedure 450 being run via communication exchanges between the first plurality of approver devices 430-1 to 430-t and the command management service 420 and this will be illustrated in more detail in FIG. 5 described below. A successful outcome of the command authorization procedure 450 results in execution 452 of the first command on the target device 440. At some point in time after the threshold coding scheme has been used to authorise execution of this first command at 452, a further approver device implements the add approver process, which includes provisioning of a further partial signing key by the command management service 420 to the further approver device. The further partial signing key provided via signal 405 may be provided in ciphertext using a public key of the further approver device 430-(t+1). The further partial signing key (plaintext version) may have been generated by the command management service simultaneously with the partial signing keys corresponding to the signal 401 and may have been stored awaiting a request to add a further approver. Alternatively, the plaintext further partial signing key may have been dynamically generated just prior to output of the signal 405. In examples where the first plurality of partial signing keys and the further partial singing key are generated in accordance with Shamir's scheme, generating the further partial singing key dynamically may comprise, for example: loading the stored polynomial f(x) based on which the first plurality of partial signing keys were generated; and calculating the further partial signing key as f(t+1). In these examples, since the first plurality of partial signing keys and the further partial signing key are generated based on the same polynomial, the further partial signing key is combinable with a plurality of the first plurality of partial signing keys to generate a valid complete signing key. Similarly partial signatures generated on the first plurality of partial signing keys are combinable with the partial signature generated on the further partial signing key to generate a valid complete signature. The first plurality of partial signing keys and the further partial signing key were both generated based on the same private threshold key, Tsk, hence they are both associated with the same public threshold key Tpk.

After the further partial signing key has been provisioned at 405 a second command request 407 to execute a further command is received from the command initiator 404. For ease of illustration, the first command request 403 and the second command request 407 in FIG. 4 are shown to originate from the same computing device and to target the same computing device. However, the second command request 407 could originate from a different command initiator device or could target a different computing device relative to the first command request 403, or the second command request 407 could both originate from a different command initiator device and target a different computing device. The first command and the second command may be different instances of the same command or may alternatively be different commands. At 454, a further command authorisation procedure is executed between the command management service 420 to include both the first plurality of approver devices 430-1 to 430-t and the further approver device 430-(t+1) that has been newly on-boarded via an add approver procedure.

The further authorisation procedure 454 may involve combining the further partial signature communicated via signal 405 with at least (t−1) of the total of t partial signatures provisioned via signal 401. Any combination or permutation of t partial signatures received from the full set of approver devices for which the add approver procedure has been executed may result in authorisation of the execution of the second command request. At a minimum, t different partial signatures are combined to effect reconstruction of the complete signature. In principle, the partial signing keys could be combined to produce the signing key, but instead, examples of the present technique securely store the signing key Tsk in the command management service 220 and use it to add approvers, for example, incrementally. As further approvers are added above and beyond t, more redundancy is provided in the system to accommodate any lack of responsiveness from individual approver devices. A lack of responsiveness in this case could be due, for example, to the approver device being currently powered down or due to a user response to a request message being pending. If the further authorisation procedure 454 results in approval of execution of the second command corresponding to the second command request 407 via verification by the target device 440 of the combination of partial signatures including the further partial signature, then the second command may be executed 456.

FIG. 5 is a signal exchange diagram that schematically illustrates an example authorization procedure corresponding, for example, to the authorisation procedure 450 illustrated in FIG. 4. The signal exchange sequence 500 involves communication between a command management service 520, a plurality of approver devices 530 and a target device 540. For the purposes of FIG. 5 it is assumed that the approver devices have already been on-boarded by the command management service 520 and have received their respective partial signing keys to securely sign incoming command requests. As shown in FIG. 5, a command request 521 from a command requesting device (not shown) is forwarded by the command management service 520 to the plurality of approver devices 530.

Approval responses signals 523 are sent from a plurality of the approver devices back to the command management service. Then via signal 525, the command together with any partial signatures provided to the command management service via the approval responses signal(s) 523 are sent to the target device associated with the command. At 542, the target device combines the partial signatures in an attempt to compute the complete signature. This is possible if at t or more authentic partial signatures are combined. The complete signature thus generated may be verified using the public key of the asymmetric key pair prior to execution of the command at 544.

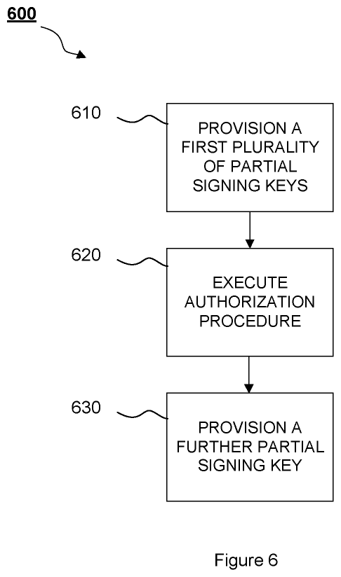

FIG. 6 depicts a flow chart 600 schematically illustrating provision of signing keys to a plurality of approver devices to authorize a requested management command. Flow chart 600 may be performed by the command management service 120 implemented on a server such as a secure server, or by any other device or by a cluster of devices in a distributer manner.

At block 610, a first plurality of partial signing keys is provisioned to a first plurality of approver devices. The first plurality of approver devices, may comprise, for example, the first plurality of approver devices 130-1 to 130-t illustrated in FIG. 1. The first plurality of partial signing keys may be provisioned to the first plurality of approver devices in accordance with any example disclosed herein. For example, the first plurality of partial singing keys may be provisioned to the first plurality of approver devices in accordance with the example signal exchange sequence shown in FIG. 4.

In some examples, prior to provisioning the first plurality of partial signing keys to the first plurality of approver devices, the example implementation shown in FIG. 6 may comprise executing a signal exchange sequence to enable encrypted communication of the partial signing keys with of the threshold scheme with the first plurality of approver devices, such as, for example, the signal exchange sequence shown in FIG. 3, which includes provision of the public encryption keys via signal 361 and 383 as part of the add approver procedure that follows the initialisation procedure during which the system administrator 102 specifies the value of t and the command management service 120 uses t to define the threshold scheme, such as by setting the coefficients of f(x) in a polynomial of order (t−1) as in Shamir's threshold scheme.

At block 620, an authorization procedure to execute a management command is executed on a target device. The target device may correspond to, for example, the target device 140 of FIG. 1. The management command may be requested by, for example, a command requestor such as the command initiator 104 also shown in FIG. 1. The authorization procedure may be in accordance with any authorization procedure disclosed herein, such as, for example, the authorizations at 450 and 454 of the example sequence shown in FIG. 4 and as shown in more detail via signals 523, and 525 and procedure 542 in FIG. 5.

At block 630, a further partial signing key is provisioned to a further approver device. The further approver device may correspond to the further approver device 130-(t+1) of FIG. 1. The further partial signing key may be provisioned to the further approver device in accordance with any example disclosed herein. For example, the further partial singing key may be provisioned to the further approver device in accordance with the example sequence shown in FIG. 4. As disclosed in relation to the example sequence shown in FIG. 4, the further partial signature may be combinable with a plurality of the first plurality of partial signatures to generate a complete signing key, which the target device 140 can use to authenticate a requested management command subject to its verification by the corresponding public key Tpk of the threshold scheme key pair. Accordingly, the example implementation shown in FIG. 6 enables the further approver device to be provided with a corresponding partial signing key to be used for participating in an authorization procedure subsequent to the provision of the first plurality of partial signing keys to the first plurality of approver devices, and without requiring that the first plurality of approver devices be re-provisioned with new partial signing keys.

In schemes that initialise the maximum number of invited approver devices at the outset, the polynomial coefficients of the threshold scheme may be deleted once the full set of partial signing keys have been generated, which would mean that adding a further approver device after a command has already been authorised would involve changing the threshold scheme by re-defining the parameters associated with the polynomial function f(x). There are other ways of adding a further approver device, but they might require multiple rounds of communication between the approver devices who may not all be online at the same time, making the task seem infeasible when performed this way. By way of contrast, according to the present technique, the same polynomial function parameters can be used for an approver added to the threshold scheme after one or more commands have already been authorized. Thus, the example implementation shown in FIG. 6 enables the further approver device to be flexibly and efficiently on-boarded to the threshold scheme such that it can participate in a multi-device authorization procedure to approve execution of a management command at a target device.

In some examples, subsequent to block 630, the example implementation shown in FIG. 6 may further comprise executing a further authorization procedure to authorize execution of a further requested management command. The further authorization procedure may be in accordance with any further authorization procedure disclosed herein, such as, for example, the further authorization procedure at 280 in the example sequence shown in FIG. 4, or the authorization procedure shown in FIG. 5.

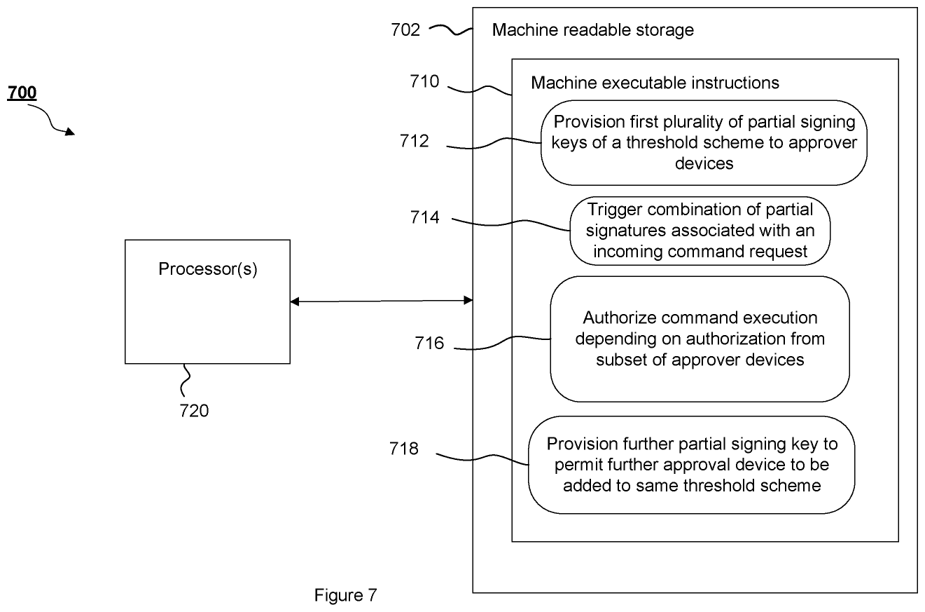

FIG. 7 schematically illustrates machine readable storage and machine readable instructions for generating, using a threshold scheme, partial signing keys for management commands. FIG. 7 shows machine readable storage 702 storing a set of machine executable instructions 710. The machine-executable instructions comprise first instructions 712 to provision a first plurality of partial signing keys of a threshold scheme to a respective plurality of approver devices in a one-to-one mapping. For example, a first partial signing key is provided to a first approver device, a second partial signing key is provided to a second approver device, a third partial signing key is provided to a third approver device and so on, where the first, second and third partial signing keys are different from each other. The set of approver devices may be command-specific or may be dependent on an originating computing device from which the command request is received or both. The machine-executable instructions comprise second code 714 to trigger combination of a plurality of partial signatures associated with an incoming command request. The combination of the partial signatures may be triggered remotely on a target device by collating any responses from the approver devices to a command authorisation request and forwarding the command signed by a given approver device using its partial signing key to the target device, where combination of a threshold number of partial signatures may be performed prior to execution of the requested command. Alternatively, the combination of the plurality of partial signatures may be performed locally by the command management service or may be performed in stages by groups of computing devices by sequentially combining subsets of the threshold number of partial signatures.

The machine-executable instructions comprise third code 716 to authorize command execution based on verification a combined version of the partial signatures, each partial signing key being device-specific. The machine-executable instructions comprise fourth code 718 to provision, if appropriate, a further partial signing key to a further computing device after one or more management command has already been executed using the given threshold sharing scheme corresponding to the command authorization performed by the third instructions 716. The fourth instructions 718 allows the further device to be added to a set of approver devices to be notified of any incoming command requests and to participate in collaborative authorisation of any future incoming command requests. The machine executable instructions may be executed on one or more processor(s) 720. The processor(s) may be in a single computing device or may alternatively be distributed between two or more different computing devices of the computing system.

The instructions 710, 712, 714, 716, and 718 may be processed by general purpose processing circuitry configured by program instructions to perform specified processing functions. The circuitry may also be configured by modification to the processing hardware. The configuration of the circuitry to perform a specified function may be limited exclusively to hardware, limited exclusively to software, or a combination of hardware modification and software execution. Program instructions may be used to configure the logic gates of general purpose or special purpose processing circuitry to perform a processing function.

Circuitry may be implemented, for example, as a hardware circuit comprising processors, microprocessors, circuits, circuit elements (e.g., transistors, resistors, capacitors, inductors, and so forth), integrated circuits, application specific integrated circuits, programmable logic devices, digital signal processors, field programmable gate arrays, logic gates, registers, semiconductor devices, chips, microchips, chip sets, and the like.

The processor(s) 720 of FIG. 7 may comprise general purpose processors, network processors that process data communicated over a computer network, graphics processing units or other types of processor, including reduced instruction set computers or complex instruction set computers. Each processor may have a single or a multiple core design. Multiple core processors may integrate different processor core types on the same integrated circuit die.

The command management service 120 may be implemented in whole or in part by machine-readable program instructions. Machine-readable program instructions may be provided on a transitory medium, such as a transmission medium, or on a non-transitory medium, such as a storage medium. These machine-readable instructions (computer program instructions) may be implemented in a high level procedural or object oriented programming language. However, the program(s) may be implemented in assembly or machine language, if desired. In any case, the language may be a compiled or interpreted language, and combined with hardware implementations.

Examples of the present disclosure are applicable for use with all types of semiconductor integrated circuit (IC) chips. Examples of these IC chips include but are not limited to processors, controllers, chipset components, programmable logic arrays, memory chips, and network chips. One or more of the components described herein may be embodied as a System On Chip (SOC) device. A SOC may include, for example, one or more Central Processing Unit cores, one or more Graphics Processing Unit cores, an Input/Output interface, and a memory controller. In some examples, a SOC and its components may be provided on one or more integrated circuit die; for example, they may be packaged into a single semiconductor device.

As used herein, a basic input/output system (BIOS) refers to hardware or hardware and instructions to initialize, control, or operate a computing device prior to execution of an operating system (OS) of the computing device. Instructions included within a BIOS may be software, firmware, microcode, or other programming that defines or controls functionality or operation of a BIOS. In one example, a BIOS may be implemented using instructions, such as platform firmware of a computing device, executable by a processor. A BIOS may operate or execute prior to the execution of the OS of a computing device. A BIOS may initialize, control, or operate components such as hardware components of a computing device and may load or boot the OS of computing device.

In some examples, a BIOS may provide or establish an interface between hardware devices or platform firmware of the computing device and an OS of the computing device, via which the OS of the computing device may control or operate hardware devices or platform firmware of the computing device. In some examples, a BIOS may implement the Unified Extensible Firmware Interface (UEFI) specification or another specification or standard for initializing, controlling, or operating a computing device.

The disclosure also extends to the following examples.

Example 1: An apparatus comprising: processing circuitry to: provision a first public key and a first plurality of partial signing keys of a first coding scheme to a set of first approver devices, each partial signing key of the first plurality being provided to an associated approver device; receive a request to execute a management command and communicate the request to multiple ones of the first plurality of approver devices; receive, responsive to the communicated request, a threshold number of different partial signatures indicating approval for execution of the management command by enabling a combination of the threshold number of different partial signatures to generate a complete signature; and provision, after execution of the management command, a further partial signing key to a further approver device, wherein a partial signature produced using the further partial signing key is combinable with one less than the threshold number of partial signatures produced using different ones of the partial signing keys to generate a further complete signature verifiable using the first public key of the first coding scheme.

Example 2: The apparatus of Example 1, wherein the processing circuitry is further to: receive the plurality of received partial signing keys from the set of first approver devices.

Example 3: The apparatus of any preceding example, wherein the complete signature is verified by a public key for authorizing execution of a management command.

Example 4: The apparatus of any preceding example, wherein the processing circuitry is further to: receive a request to execute the management command; and execute the authorization procedure based on the received request.

Example 5: The apparatus of any preceding example, wherein the management command is to execute at a first device remote from the apparatus.

Example 6: The apparatus of Example 5, wherein the first device is one of: comprised within the set of first approver devices; the further approver device; and a device remote from the first plurality of approver devices and the further approver device.

Example 7: The apparatus of any preceding example, wherein the processing circuitry is to combine multiple ones of the plurality of received partial signatures.

Example 8: The apparatus of any one of Examples 5 to 7, wherein the processing circuitry is to communicate the plurality of partial signatures or the complete signature to the first device to trigger combination of the plurality of received partial signing keys at the first device.

Example 9: The apparatus of any preceding Example, wherein the first plurality of partial signing keys and the further partial signing key are generated in accordance with a threshold key generation algorithm.

Example 10: The apparatus of Example 9, wherein both the first plurality of partial signing keys and the further partial signing key are generated in accordance with the same threshold signature scheme having the same characteristic parameters.

Example 11: The apparatus of Example 9 or Example 10, wherein the threshold signature scheme comprises any one of: a threshold signature scheme a threshold Rivest-Shamir-Adleman (RSA) scheme; a threshold Digital Signature Algorithm (DSA) scheme; a threshold Elliptic Curve Digital Signature Algorithm (ECDSA) scheme; and a threshold Schnorr signature scheme.

Example 12: The apparatus of any preceding example, wherein the first plurality of partial signing keys comprises t partial signing keys, and wherein the set of first approver devices comprises t approver devices, wherein t is a non-zero integer corresponding to a threshold number of the threshold scheme.

Example 13: The apparatus of any preceding example, wherein the plurality of partial signatures received from the approver devices responsive to the request for authorisation of the management command comprises t partial signatures, wherein t is a non-zero integer corresponding to a threshold number of the threshold scheme.

Example 14: The apparatus of any preceding example, wherein the management command is any one of: a find command; a wipe command; a lock command; a command to trigger a firmware update; a command to trigger a software update; and a command to modify a basic input/output system (BIOS) setting.

Example 15: The apparatus of any preceding example, wherein the processing circuitry is to: receive, responsive to a request for execution of a further command, a threshold number of partial signatures on the further command including a partial signature generated using the further partial signing key; and provision the further partial signature or provision a complete signature generated based on the partial signature generated using the further partial signing key, to a target device on which the further command is to be executed.

Example 16: The apparatus of any preceding example, wherein the processing circuitry is to: obtain a list of n approver devices to be provided with respective partial signing keys, wherein n is a non-zero integer and wherein the first plurality of approver devices comprises a number of approver devices less than n.

Example 17: A system comprising: the apparatus of any preceding example; a set of first approver devices; and a further approver device.

Example 18: A computer readable medium comprising machine readable instructions which, when processed by processing circuitry is to:
provision a first plurality of partial signing keys to a set of first approver devices in a one-to-one mapping, the first plurality of partial signing keys having been generated in accordance with a threshold coding scheme and to further provision a first public key to the set of first approver devices;
receive a request to execute a command and forward the request to the set of first approver devices;
receive, responsive to the forwarded request, a threshold number of distinct partial signatures indicating approval for execution of the command, the approval to be verified by combining of the threshold number of different partial signatures to generate a complete signature;
   and
provision, following execution of the approved command, a further partial signing key to a further approver device, the further partial signing key corresponding to the first public key of the first coding scheme.

Example 19: The computer-readable medium of Example 18, wherein the management command for which approval is requested is a management command to be performed on a plurality of different devices of a computing system.

Example 20: The computer readable media of Example 18 or Example 19, wherein the complete signing key is for authorizing execution of a management command.

Example 21: The computer readable media of any one of Examples 18-20, wherein the instructions, when executed by processing circuitry are further to: receive a request to execute the management command; and execute the authorization procedure based on the received request.

Example 22: The computer readable media of any one of Examples 18-21, wherein the management command is to execute at a first device remote from the processing circuitry of Example 18.

Example 23: The apparatus of Example 5, wherein the first device is one of: comprised within the set of first approver devices; the further approver device; and a device remote from the set of first approver devices and the further approver device.

Example 24: The apparatus of any preceding example, wherein the processing circuitry is to combine the plurality of received partial signatures.

Example 25: The apparatus of any one of Examples 22 to 24, wherein the processing circuitry is to communicate the plurality of received partial signatures to the first device to trigger combination of the plurality of received partial signatures at the first device.

Example 26: The apparatus of any preceding Example, wherein the first plurality of partial signing keys and the further partial signing key are generated in accordance with a threshold scheme.

Example 27: The apparatus of Example 9, wherein both the first plurality of partial signing keys and the further partial signing key are generated in accordance with the same threshold scheme having the same characteristic parameters (e.g. the same polynomial coefficients).

Example 28: The apparatus of any preceding example, wherein the first plurality of partial signing keys comprises t partial signing keys, and wherein the set of first approver devices comprises t approver devices, wherein t is a non-zero integer corresponding to a threshold number of the threshold scheme.

Example 29: The apparatus of any preceding example, wherein the plurality of received partial signatures comprises t partial signatures, wherein t is a non-zero integer corresponding to a threshold number of the threshold scheme.

Example 30: The apparatus of any preceding example, wherein the management command is any one of: a find command; a wipe command; a lock command; a command to trigger a firmware update; a command to trigger a software update; and a command to modify at a basic input/output system (BIOS) setting.

Example 31: The apparatus of any preceding example, wherein the processing circuitry is to: receive, responsive to a request for execution of a further command, a threshold number of partial signatures on the further command including a further partial signature generated using the further partial signing key; and provision the further partial signature or provision a complete signature generated based on the further partial signature, to a target device on which the further command is to be executed.

Example 33: The apparatus of any preceding example, wherein the processing circuitry is to: obtain a list of n approver devices to be provided with respective partial signing keys, wherein n is a non-zero integer; wherein the first plurality of approver devices comprises a number of approver devices less than n.

In some examples, the further approver device may be one of the first approver devices. This may apply when a level of trust of an approver is increased such that the approver may approve a command collaboratively with fewer other approvers than previously.

1. An apparatus comprising:
processing circuitry to:
provision a first public key and a first plurality of partial signing keys of a first coding scheme to a set of first approver devices, each partial signing key of the first plurality being provided to an associated approver device;
receive a request to execute a management command and communicate the request to the set of first approver devices;
receive, responsive to the communicated request, a threshold number of different partial signatures indicating approval for execution of the management command by enabling a combination of the threshold number of different partial signatures to generate a complete signature; and
provision, after execution of the management command, a further partial signing key to a further approver device, wherein a partial signature produced using the further partial signing key is combinable with one less than the threshold number of partial signatures produced using different ones of the partial signing keys to generate a further complete signature verifiable using the first public key of the first coding scheme.

2. The apparatus of claim 1, wherein the first plurality of partial signing keys comprises t partial signing keys of the first coding scheme, and wherein the set of first approver devices comprises t approver devices, wherein t is a non-zero integer corresponding to a threshold number of the threshold sharing scheme.

3. The apparatus of claim 2, wherein the plurality of partial signatures, received responsive to a request for authorisation of a management command sent to the set of first approver devices, comprises t partial signatures produced using the partial signing keys, wherein t is a non-zero integer corresponding to a threshold number of the threshold scheme.

4. The apparatus of claim 1, wherein the management command is to execute at a device remote from the set of first approver devices.

5. The apparatus of claim 1, wherein the management command is any one of: a find command; a wipe command; a lock command; a command to trigger a firmware update; a command to trigger a software update; and a command to modify a basic input/output system, BIOS, setting.

6. The apparatus of claim 1, wherein the processing circuitry is to:
receive, responsive to a request for execution of a further command, a threshold number of partial signatures on the further command including a further partial signature generated using the further partial signing key; and
provision the further partial signing key or provision a complete signing key generated based on the further partial signature, to a target device on which the further command is to be executed.

7. The apparatus of claim 1, wherein the processing circuitry is to:
obtain a list of n approver devices each to be provided with respective different partial signing keys of the first coding scheme, wherein n is a non-zero integer;
wherein the set of first approver devices comprises a number of approver devices less than n.

8. A computing system comprising:
an apparatus to add approver devices to a command authorisation protocol;
a set of first approver devices; and
a further approver device;
wherein the apparatus is to:
provision each of t first partial signing keys to the set of first approver devices, wherein t corresponds to a threshold number of a threshold scheme and wherein t is a non-zero integer and provision a first public key related to the first partial signing keys to the set of first approver devices;
receive a request to execute a first management command and relay the request to the set of first approver devices;
receive, responsive to the relayed request, a threshold number of different first partial signatures produced using the first partial signing keys, indicating approval for execution of the first management command, the execution to be performed when the threshold number of different first partial signatures is combined to generate a complete signature;
and
provision a further partial signing key to a further approver device, a further partial signature produced using the further partial signing key being combinable with any combination of (t−1) of the first partial signatures to generate a further complete signature verifiable using the first public key to authorise execution of a second management command.

9. The computing system of claim 8, wherein the t first partial signing keys and the further partial signing key are generated in accordance with one of: Shamir's scheme, Blakely's scheme, Mignotte's scheme and Asmuth-Bloom's scheme.

10. The computing system of claim 8, wherein the management command is any one of: a find command; a wipe command; a lock command; a command to trigger a firmware update; a command to trigger a software update; and a command to modify at a basic input/output system (BIOS) setting.

11. The computing system of claim 8, wherein the apparatus is to:
trigger combination of t partial signatures of the threshold scheme to generate a further complete signature, the received partial signatures including a partial signature received from the further approver device.

12. The computing system of claim 8, wherein the apparatus is to:
obtain a list of n approver devices to be provided with respective partial signing keys, wherein n is a non-zero integer greater than t.

13. A non-transitory computer-readable storage medium comprising instructions that when executed cause processing circuitry of a computing device to:
provision a first public key and a first plurality of partial signing keys of a first coding scheme to a set of first approver devices, the first plurality of partial signing keys having been generated in accordance with a threshold coding scheme;
receive a request to execute a command and forward the request to the set of first approver devices;
receive, responsive to the forwarded request, a threshold number of distinct partial signatures indicating approval for execution of the command, the approval to be verified by combining of the threshold number of different partial signatures keys to generate a complete signature;
and
provision, following execution of the approved command, a further partial signing key to a further approver device, the further partial signing key being associated with the first coding scheme and the first public key.

14. The non-transitory computer-readable storage medium of claim 13, comprising instructions that when executed cause processing circuitry of a computing device to:
receive, responsive to a request for execution of a further command, a threshold number of partial signatures on the further command including a further partial signature generated using the further partial signing key; and
provision the further partial signature or provision a complete signature generated using the further partial signature, to a target device on which the further command is to be executed.

15. The non-transitory computer-readable storage medium of claim 13, comprising instructions that when executed cause processing circuitry of a computing device to encrypt a partial signing key of the first plurality of partial signing keys using a public key of an asymmetric key pair generated by an approver device to which the one of the partial signing keys is destined, prior to performing the provisioning of the first plurality of partial signing keys to the plurality of approver devices.
